(19) United States
(12) Patent Application Publication
(10) Pub. No.: US 2021/0088342 A1
(43) Pub. Date: Mar. 25, 2021

(54) SYSTEMS AND METHODS FOR NAVIGATION SERVICES

(71) Applicant: BEIJING DIDI INFINITY TECHNOLOGY AND DEVELOPMENT CO., LTD., Beijing (CN)

(72) Inventor: Yan LI, Beijing (CN)

(73) Assignee: BEIJING DIDI INFINITY TECHNOLOGY AND DEVELOPMENT CO., LTD., Beijing (CN)

(21) Appl. No.: 17/093,554

(22) Filed: Nov. 9, 2020

Related U.S. Application Data
(63) Continuation of application No. PCT/CN2019/089392, filed on May 31, 2019.

(30) Foreign Application Priority Data
Jun. 13, 2018 (CN) 201810604491.9

(51) Int. Cl. G01C 21/34; G01C 21/36; G01S 19/42; H04W 4/02; H04W 4/024

(52) U.S. Cl. CPC G01C 21/3407; G01C 21/3679; H04W 4/024; G01S 19/42; H04W 4/027; G01C 21/3658

(57) ABSTRACT

The present disclosure relates to systems and methods for providing navigation services. The method may include obtaining a start location and a destination of a navigation request from a terminal device. The method may include determining a navigation path based on the start location and the destination. The method may also include determining at least one broadcast point and navigation broadcast information associated with each of the at least one broadcast point based on the navigation path. The method may further include transmitting the navigation broadcast information to the terminal device to cause the terminal device to provide a navigation broadcast service to a subject.

### CROSS-REFERENCE TO RELATED APPLICATIONS

This application is a continuation of International Patent Application No. PCT/CN2019/089392, filed on May 31, 2019, which claims priority of Chinese Patent Application No. 201810604491.9 filed on Jun. 13, 2018, the contents of each of which are incorporated herein by reference in their entirety.

### TECHNICAL FIELD

The present disclosure generally relates to navigation services, and in particular, to systems and methods for navigation broadcast.

### BACKGROUND

With the development of traffic environment and the increasing travel demand, navigation services become more and more important. A system for providing navigation services may be implemented on a navigation terminal (e.g., a built-in device), which requires a large storage capacity and a powerful computing capacity. Therefore, it is desirable to provide systems and methods for providing navigation services efficiently and accurately via an optimized system, thereby improving resource utilization and service effectiveness.

### SUMMARY

An aspect of the present disclosure relates to a cloud service-based navigation broadcast method. The method may be executed in a terminal device, wherein the terminal device may be connected to a server via a network. The method may include obtaining a start location and a destination of a navigation request; transmitting the start location and the destination of the navigation request to the server; obtaining, from the server, a set of first navigation broadcast information, wherein the set of first navigation broadcast information may include at least one broadcast point and first navigation broadcast information associated with the at least one broadcast point; obtaining a current travelling state; determining second navigation broadcast information based on the set of first navigation broadcast information and the current travelling state; and broadcasting the second navigation broadcast information.

In some embodiments, the first navigation broadcast information may include at least one placeholder to be filled by at least one of velocity information or distance information.

In some embodiments, the determining the second navigation broadcast information based on the set of first navigation broadcast information and the current travelling state may include determining a broadcast point based on the current travelling state; determining first navigation broadcast information associated with the broadcast point; and filling the placeholder in the first navigation broadcast information to obtain second navigation broadcast information based on the first navigation broadcast information associated with the broadcast point and the current travelling state.

In some embodiments, the determining the second navigation broadcast information based on the set of first navigation broadcast information and the current travelling state may include determining a broadcast point based on the current travelling state; determining first navigation broadcast information associated with the broadcast point; and determining the first navigation broadcast information associated with the broadcast point as the second navigation broadcast information.

In some embodiments, the second navigation broadcast information may be broadcast in at least one of a voice broadcast mode and/or a text broadcast mode.

In some embodiments, the first navigation broadcast information may further include a valid broadcast distance and/or a broadcast attribute.

In some embodiments, the current travelling state may include a current location and/or a current velocity.

Another aspect of the present disclosure relates to a cloud service-based navigation method. The method may include obtaining a start location and a destination of a navigation request; determining a navigation path based on the start location and the destination; determining at least one broadcast point on the navigation path; and determining first navigation broadcast information associated with the at least one broadcast point.

In some embodiments, the first navigation broadcast information may include at least one placeholder to be filled by at least one of velocity information or distance information.

In some embodiments, the determining the first navigation broadcast information associated with the at least one broadcast point may include obtaining relevant information associated with the broadcast point, wherein the relevant information may include at least one of a turning angle, a road line type, and/or a lane change; and determining, based on the relevant information associated with the broadcast point, the first navigation broadcast information associated with the broadcast point.

A further aspect of the present disclosure relates to a cloud service-based navigation broadcast system. The system may include an obtaining module, a transmission module, a determination module, and a broadcast module. The obtaining module may include a first obtaining unit, a second obtaining unit, and a third obtaining unit. The first obtaining unit may be configured to obtain a start location and a destination of a navigation request; the second obtaining unit may be configured to obtain a current travelling state; and the third obtaining unit may be configured to obtain, from a server, a set of first navigation broadcast information, wherein the set of first navigation broadcast information may include at least one broadcast point and first navigation broadcast information associated with the at least one broadcast point. The transmission module may be configured to transmit the start location and the destination to the server. The determination module may be configured to determine second navigation broadcast information based on the set of first navigation broadcast information and the current travelling state. The broadcast module may be configured to broadcast the second navigation broadcast information.

In some embodiments, the first navigation broadcast information may include at least one placeholder to be filled by at least one of velocity information or distance information.

In some embodiments, the determination module may include a first determination unit, a second determination unit, and a third determination unit. The first determination unit may configured to determine a broadcast point based on the current travelling state. The second determination unit may be configured to determine first navigation broadcast information associated with the broadcast point. The third determination unit may be configured to fill the placeholder in the first navigation broadcast information to obtain the second navigation broadcast information based on the first navigation broadcast information associated with the broadcast point and the current travelling state.

In some embodiments, the determination module may include a first determination unit, a second determination unit, and a third determination unit. The first determination unit may be configured to determine a broadcast point based on the current travelling state. The second determination unit may be configured to determine first navigation broadcast information associated with the broadcast point. The third determination unit may be configured to determine the first navigation broadcast information associated with the broadcast point as the second navigation broadcast information.

In some embodiments, the second navigation broadcast information may be broadcast in at least one of a voice broadcast mode and/or a text broadcast mode.

In some embodiments, the first navigation broadcast information may further include a valid broadcast distance and/or a broadcast attribute.

In some embodiments, the current travelling state may include a current location and/or a current velocity.

A still further aspect of the present disclosure relates to a cloud service-based navigation system. The system may include an obtaining module and a determination module. The obtaining module may be configured to obtain a start location and a destination of a navigation request. The determination module may include a first determination unit, a second determination unit, and a third determination unit. The first determination unit may be configured to determine a navigation path based on the start location and the destination; the second determination unit may be configured to determine at least one broadcast point on the navigation path; the third determination unit may be configured to determine first navigation broadcast information associated with the at least one broadcast point.

In some embodiments, the first navigation broadcast information may include at least one placeholder to be filled by at least one of velocity information or distance information.

In some embodiments, the third determination unit may include an obtaining sub-unit and a determination sub-unit. The obtaining sub-unit may be configured to obtain relevant information associated with the broadcast point, wherein the relevant information may include at least one of a turning angle, a road line type, and/or a lane change. The determination sub-unit may be configured to determine, based on the relevant information associated with the broadcast point, the first navigation broadcast information associated with the broadcast point.

A still further aspect of the present disclosure relates to a navigation broadcast device. The device may include a processor configured to execute the above methods.

A still further aspect of the present disclosure relates to a computer readable storage medium storing computer instructions. When a computer reads the computer instructions in the storage medium, the computer may executes the above methods.

A still further aspect of the present disclosure relates to a system for providing navigation services. The system may include a storage device to store a set of instructions and a processor communicatively coupled to the storage device and to execute the set of instructions. The system may obtain, from a terminal device, a start location and a destination of a navigation request. The system may determine a navigation path based on the start location and the destination. The system may determine at least one broadcast point and navigation broadcast information associated with each of the at least one broadcast point based on the navigation path. The system may also transmit the navigation broadcast information to the terminal device to cause the terminal device to provide a navigation broadcast service to a subject.

In some embodiments, the navigation broadcast information may include at least one placeholder to be replaced by reminder information.

In some embodiments, the navigation broadcast service may be provided by placing distance reminder information or velocity reminder information in the at least one placeholder based on a current travelling state of the subject.

In some embodiments, the current travelling state may include at least one of a current location of the subject and/or a current velocity of the subject.

In some embodiments, the current travelling state of the subject may be determined based on positioning information.

In some embodiments, the navigation path may include a sequence of road sections. The system may determine reference information associated with the sequence of road sections, the reference information including at least one of an angle between any two adjacent road sections, a road line type, and/or a lane change. The system may determine the at least one broadcast point and the navigation broadcast information associated with each of the at least one broadcast point based on the reference information.

In some embodiments, the navigation broadcast information may include at least one of a valid broadcast distance and/or a broadcast attribute.

In some embodiments, the at least one broadcast point may include an intersection, a turning point, an on-ramp point, and/or an off-ramp point.

In some embodiments, the navigation broadcast service may be provided in at least one of a voice broadcast mode and/or a text broadcast mode.

In some embodiments, the system may further obtain at least one recommendation based on the navigation path, the at least one recommendation including at least one of a gas station recommendation, a vehicle maintenance recommendation, or a personalized recommendation. The system may also transmit the recommendation to the terminal device during providing the navigation broadcast service for the subject.

A still further aspect of the present disclosure relates to a method. The method may be implemented on a computing device having at least one processor, at least one storage medium, and a communication platform connected to a network. The method may include obtaining a start location and a destination of a navigation request from a terminal device. The method may include determining a navigation path based on the start location and the destination. The method may include determining at least one broadcast point and navigation broadcast information associated with each of the at least one broadcast point based on the navigation path. The method may include transmitting the navigation broadcast information to the terminal device to cause the terminal device to provide a navigation broadcast service to a subject.

In some embodiments, the navigation broadcast information may include at least one placeholder to be replaced by reminder information.

In some embodiments, the navigation broadcast service may be provided by placing distance reminder information or velocity reminder information in the at least one placeholder based on a current travelling state of the subject.

In some embodiments, the current travelling state may include at least one of a current location of the subject and/or a current velocity of the subject.

In some embodiments, the current travelling state of the subject may be determined based on positioning information.

In some embodiments, the navigation path may include a sequence of road sections. The determining, based on the navigation path, the at least one broadcast point and the navigation broadcast information associated with each of the at least one broadcast point may include determining reference information associated with the sequence of road sections, the reference information including at least one of an angle between any two adjacent road sections, a road line type, or a lane change; and determining the at least one broadcast point and the navigation broadcast information associated with each of the at least one broadcast point based on the reference information.

In some embodiments, the navigation broadcast information may include at least one of a valid broadcast distance and/or a broadcast attribute.

In some embodiments, the at least one broadcast point may include an intersection, a turning point, an on-ramp point, and/or an off-ramp point.

In some embodiments, the navigation broadcast service may be provided in at least one of a voice broadcast mode and/or a text broadcast mode.

In some embodiments, the method may further include obtaining at least one recommendation based on the navigation path, the at least one recommendation including at least one of a gas station recommendation, a vehicle maintenance recommendation, and/or a personalized recommendation. The method may also include transmitting the recommendation to the terminal device during providing the navigation broadcast service for the subject.

A still further aspect of the present disclosure relates to a system for providing navigation services. The system may include an obtaining module, a determination module, and a transmission module. The obtaining module may be configured to obtain a start location and a destination of a navigation request from a terminal device. The determination module may be configured to determine a navigation path based on the start location and the destination and determine at least one broadcast point and navigation broadcast information associated with each of the at least one broadcast point based on the navigation path. The transmission module may be configured to transmit the navigation broadcast information to the terminal device to cause the terminal device to provide a navigation broadcast service to a subject.

In some embodiments, the navigation broadcast information may include at least one placeholder to be replaced by reminder information.

In some embodiments, the navigation broadcast service may be provided by placing distance reminder information or velocity reminder information in the at least one placeholder based on a current travelling state of the subject.

In some embodiments, the current travelling state may include at least one of a current location of the subject and/or a current velocity of the subject.

In some embodiments, the current travelling state of the subject may be determined based on positioning information.

In some embodiments, the navigation path may include a sequence of road sections. The determination module may be configured to determine reference information associated with the sequence of road sections, the reference information including at least one of an angle between any two adjacent road sections, a road line type, or a lane change. The determination module may be also configured to determine the at least one broadcast point and the navigation broadcast information associated with each of the at least one broadcast point based on the reference information.

In some embodiments, the navigation broadcast information may include at least one of a valid broadcast distance and/or a broadcast attribute.

In some embodiments, the at least one broadcast point may include an intersection, a turning point, an on-ramp point, and/or an off-ramp point.

In some embodiments, the navigation broadcast service may be provided in at least one of a voice broadcast mode and/or a text broadcast mode.

In some embodiments, the obtaining module may be further configured to obtain at least one recommendation based on the navigation path, the at least one recommendation including at least one of a gas station recommendation, a vehicle maintenance recommendation, or a personalized recommendation. The transmission module may be further configured to transmit the recommendation to the terminal device during providing the navigation broadcast service for the subject.

A still further aspect of the present disclosure relates to a non-transitory computer readable medium. The non-transitory computer readable medium may include a set of instructions for providing navigation services. When executed by at least one processor, the set of instructions direct the at least one processor to effectuate the method described above.

A still further aspect of the present disclosure relates to a method. The method may be implemented on a computing device including at least one processor, at least one storage medium, and a communication platform connected to a network. The method may include obtaining a start location and a destination of a navigation request; transmitting the start location and the destination to a server; obtaining at least one broadcast point and navigation broadcast information associated with each of the at least one broadcast point, wherein at least one broadcast point and navigation broadcast information associated with each of the at least one broadcast point may be determined based on a navigation path determined based on the start location and the destination; and providing a navigation broadcast service to a subject.

In some embodiments, the navigation broadcast information may include at least one placeholder to be replaced by reminder information.

In some embodiments, the providing the navigation broadcast service may include placing distance reminder information or velocity reminder information in the at least one placeholder based on a current travelling state of the subject.

In some embodiments, the current travelling state may include at least one of a current location of the subject and/or a current velocity of the subject.

In some embodiments, the current travelling state of the subject may be determined based on positioning information.

In some embodiments, the navigation path may include a sequence of road sections. The at least one broadcast point and the navigation broadcast information associated with each of the at least one broadcast point may be determined based on reference information associated with the navigation path, the reference information including at least one of an angle between any two adjacent road sections, a road line type, and/or a lane change.

In some embodiments, the navigation broadcast information may include at least one of a valid broadcast distance and/or a broadcast attribute.

In some embodiments, the at least one broadcast point may include an intersection, a turning point, an on-ramp point, and/or an off-ramp point.

In some embodiments, the providing the navigation broadcast service may include providing the navigation broadcast service in at least one of a voice broadcast mode and/or a text broadcast mode.

In some embodiments, the method may further include obtaining at least one recommendation based on the navigation path, the at least one recommendation including at least one of a gas station recommendation, a vehicle maintenance recommendation, and/or a personalized recommendation; and providing the at least one recommendation to the subject during providing the navigation broadcast service to the subject.

A still further aspect of the present disclosure relates to a system for providing navigation services. The system may include an obtaining module, a transmission module, a determination module, and a broadcast module. The obtaining module may be configured to obtain a start location and a destination of a navigation request. The transmission module may be configured to transmit the start location and the destination to a server. The determination module may be configured to obtain at least one broadcast point and navigation broadcast information associated with each of the at least one broadcast point, wherein at least one broadcast point and navigation broadcast information associated with each of the at least one broadcast point may be determined based on a navigation path determined based on the start location and the destination. The broadcast module may be configured to provide a navigation broadcast service to a subject.

A still further aspect of the present disclosure relates to a non-transitory computer readable medium. The non-transitory computer readable medium may include a set of instructions for providing navigation services. When executed by at least one processor, the set of instructions may direct the at least one processor to effectuate the above method.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary navigation service system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary mobile device according to some embodiments of the present disclosure;

FIG. 4 is a block diagram illustrating an exemplary processing engine according to some embodiments of the present disclosure;

FIG. 5 is a block diagram illustrating an exemplary determination module according to some embodiments of the present disclosure;

FIG. 6 is a block diagram illustrating an exemplary third determination unit according to some embodiments of the present disclosure;

FIG. 7 is a flowchart illustrating an exemplary process for determining and/or transmitting at least one broadcast point and navigation broadcast information according to some embodiments of the present disclosure;

FIG. 8 is a schematic diagram illustrating exemplary navigation broadcast information according to some embodiments of the present disclosure;

FIG. 9 is a schematic diagram illustrating an exemplary navigation interface according to some embodiments of the present disclosure;

FIG. 10 is a block diagram illustrating an exemplary terminal device according to some embodiments of the present disclosure;

FIG. 11 is a block diagram illustrating an exemplary obtaining module according to some embodiments of the present disclosure;

FIG. 12 is a block diagram illustrating an exemplary determination module according to some embodiments of the present disclosure;

FIG. 13 is a flowchart diagram illustrating an exemplary process for providing a navigation service according to some embodiments of the present disclosure; and

FIG. 14 is a schematic diagram illustrating an exemplary navigation service system according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation, various components of the stated system, functions of the related elements of structure, and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implemented according to some embodiments of the present disclosure. It is to be expressly understood, that the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding a navigation service on land, it should also be understood that this is only one exemplary embodiment. The systems and methods of the present disclosure may be applied to any other kind of navigation service. For example, the systems and methods of the present disclosure may be applied to transportation systems of different environments including land (e.g. roads or off-road), water (e.g. river, lake, ocean), air, aerospace, or the like, or any combination thereof. The vehicle of the transportation systems may include a taxi, a private car, a hitch, a bus, a train, a bullet train, a high-speed rail, a subway, a boat, a vessel, an aircraft, a spaceship, a hot-air balloon, a driverless vehicle, or the like, or any combination thereof. The transportation systems may also include any transportation system for management and/or distribution, for example, a system for sending and/or receiving an express. The application of the systems and methods of the present disclosure may include a mobile device (e.g. smart phone or pad) application, a webpage, a plug-in of a browser, a client terminal, a custom system, an internal analysis system, an artificial intelligence robot, or the like, or any combination thereof.

The terms “terminal,” “terminal device,” “navigation terminal,” “navigation device,” “navigation broadcast device,” “user,” “user terminal,” “navigation user,” “subject,” and “navigation subject” in the present disclosure are used interchangeably to refer to an individual, an entity, or a tool that may request or order a service. The terms “user” and “subject” in the present disclosure are used interchangeably to refer to an individual, an entity, or a tool that may request a service, order a service, provide a service, or facilitate the providing of the service. The terms “server,” “navigation server,” “server side,” “server device,” and navigation device” in the present disclosure are used interchangeably.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to systems and methods for providing navigation services. The systems may obtain a start location and a destination of a navigation request from a terminal device and determine a navigation path based on the start location and the destination. The systems may further determine at least one broadcast point and navigation broadcast information associated with each of the at least one broadcast point based on the navigation path. The systems may transmit the navigation broadcast information to the terminal device to cause the terminal device to provide a navigation broadcast service to a subject (e.g., a user, a cycle, a vehicle, an autonomous vehicle). The systems and methods of the present disclosure may be implemented on a cloud platform, through which the navigation services can be provided efficiently and accurately.

It should be noted that navigation service, overall, is a technology deeply rooted in Internet world. Providing a navigation service for a subject (e.g., a user, a cycle, a vehicle, an autonomous vehicle) without using a map is not possible without the possibility of real-time GPS positioning and real-time communication between a terminal device and a remote server. Therefore, the technical solution disclosed in the present disclosure is also a technology deeply rooted in Internet era.

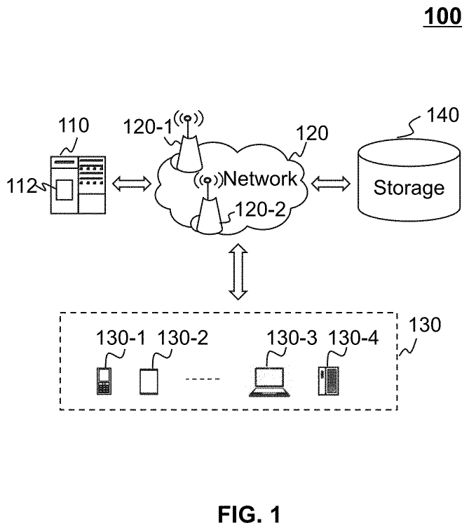

FIG. 1 is a schematic diagram illustrating an exemplary navigation service system according to some embodiments of the present disclosure. In some embodiments, the navigation service system 100 may be an online navigation service platform for providing navigation services such as land navigation services (e.g., a driving navigation service, a walking navigation service, a cycling navigation service), marine navigation services, aerospace navigation services, or the like, or any combination thereof. In some embodiments, the application scenario of the navigation service system 100 may include private travelling, taxi hailing, chauffeur service, delivery vehicle, express car, carpool, bus service, driver hiring, shuttle service, etc. In some embodiments, the navigation service system 100 may provide an indoor navigation service or an outdoor navigation service. In some embodiments, the navigation service system 100 may include a server 110, a network 120, a terminal device 130, and a storage 140.

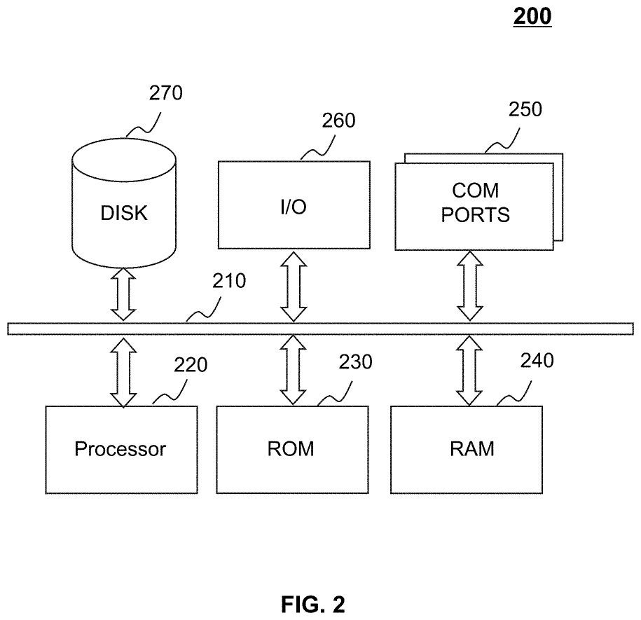

In some embodiments, the server 110 may be a single server or a server group. The server group may be centralized or distributed (e.g., server 110 may be a distributed system). In some embodiments, the server 110 may be local or remote. For example, the server 110 may access information and/or data stored in the terminal device 130 and/or the storage 140 via the network 120. As another example, the server 110 may be directly connected to the terminal device 130 and/or the storage 140 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 including one or more components illustrated in FIG. 2.

In some embodiments, the server 110 may include a processing engine 112. The processing engine 112 may process information and/or data relating to a service request (e.g., a navigation request) to perform one or more functions described in the present disclosure. For example, the processing engine 112 may determine a navigation path based on the navigation request and determine at least one broadcast point and navigation broadcast information associated with the at least one broadcast point based on the navigation path. In some embodiments, the processing engine 112 may include a path planning engine configured to determine the navigation path and a navigation broadcast engine configured to determine the at least one broadcast point and navigation broadcast information. In some embodiments, the processing engine 112 may include one or more processing engines (e.g., single-core processing engine(s) or multi-core processor(s)). The processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof. In sme embodiments, the processing engine 112 may be integrated in the terminal device 130.

The network 120 may facilitate exchange of information and/or data. In some embodiments, one or more components (e.g., the server 110, the terminal device 130, or the storage 140) of the navigation service system 100 may transmit information and/or data to other component(s) of the navigation service system 100 via the network 120. For example, the server 110 may obtain a service request from the terminal device 130 via the network 120. In some embodiments, the network 120 may be any type of wired or wireless network, or any combination thereof. Merely by way of example, the network 120 may include a cable network, a wireline network, an optical fiber network, a telecommunications network, an intranet, an Internet, a Local Area Network (LAN), a Wide Area Network (WAN), a Wireless Local Area Network (WLAN), a Metropolitan Area Network (MAN), a Public Telephone Switched Network (PSTN), a BLUETOOTH network, a ZIGBEE network, a Near Field Communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the navigation service system 100 may be connected to the network 120 to exchange data and/or information.

In some embodiments, a service requester may be a user of the terminal device 130. In some embodiments, the user of the terminal device 130 may be someone other than the service requester. For example, a user A of the terminal device 130 may use the terminal device 130 to send a service request for a user B or receive a service confirmation and/or information or instructions from the server 110.

In some embodiments, the terminal device 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, a built-in device in the vehicle 130-4 may include an onboard computer, an onboard television, etc. In some embodiments, the terminal device 130 may be a device with positioning technology for locating the location of the service requester and/or the terminal device 130.

The storage 140 may store data and/or instructions relating to the service request. In some embodiments, the storage 140 may store data obtained from the terminal device 130. In some embodiments, the storage 140 may store data and/or instructions that the server 110 may execute or use to perform exemplary methods described in the present disclosure. In some embodiments, the storage 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 140 may be connected to the network 120 to communicate with one or more components (e.g., the server 110, the terminal device 130) of the navigation service system 100. One or more components of the navigation service system 100 may access the data and/or instructions stored in the storage 140 via the network 120. In some embodiments, the storage 140 may be directly connected to or communicate with one or more components (e.g., the server 110, the terminal device 130) of the navigation service system 100. In some embodiments, the storage 140 may be part of the server 110.

In some embodiments, one or more components (e.g., the server 110, the terminal device 130) of the navigation service system 100 may have permissions to access the storage 140. In some embodiments, one or more components of the navigation service system 100 may read and/or modify information relating to the service requester, the service provider, and/or the public when one or more conditions are met. For example, the server 110 may read and/or modify one or more service requesters' information after a service is completed.

In some embodiments, information exchanging of one or more components of the navigation service system 100 may be achieved by way of requesting a service. The object of the service request may be any product. In some embodiments, the product may be a tangible product or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle), a car (e.g., a taxi, a bus, a private car), a train, a subway, a vessel, an aircraft (e.g., an airplane, a helicopter, a space shuttle, a rocket, a hot-air balloon), or the like, or any combination thereof.

One of ordinary skill in the art would understand that when an element (or component) of the navigation service system 100 performs, the element may perform through electrical signals and/or electromagnetic signals. For example, when the terminal device 130 transmits out a service request to the server 110, a processor of the terminal device 130 may generate an electrical signal encoding the request. The processor of the terminal device 130 may then transmit the electrical signal to an output port. If the terminal device 130 communicates with the server 110 via a wired network, the output port may be physically connected to a cable, which further may transmit the electrical signal to an input port of the server 110. If the terminal device 130 communicates with the server 110 via a wireless network, the output port of the terminal device 130 may be one or more antennas, which convert the electrical signal to electromagnetic signal. Within an electronic device, such as the terminal device 130 and/or the server 110, when a processor thereof processes an instruction, transmits out an instruction, and/or performs an action, the instruction and/or action is conducted via electrical signals. For example, when the processor retrieves or saves data from a storage medium (e.g., the storage 140), it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and/or software components of an exemplary computing device according to some embodiments of the present disclosure. In some embodiments, the server 110 may be implemented on the computing device 200. For example, the processing engine 112 may be implemented on the computing device 200 and configured to perform functions of the processing engine 112 disclosed in this disclosure.

The computing device 200 may be used to implement any component of the navigation service system 100 as described herein. For example, the processing engine 112 may be implemented on the computing device 200, via its hardware, software program, firmware, or a combination thereof. Although only one such computer is shown, for convenience, the computer functions relating to the navigation service as described herein may be implemented in a distributed fashion on a number of similar platforms to distribute the processing load.

The computing device 200 may include COM ports 250 connected to and from a network connected thereto to facilitate data communications. The computing device 200 may also include a processor 220, in the form of one or more processors (e.g., logic circuits), for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms including, for example, a disk 270, a read only memory (ROM) 230, or a random access memory (RAM) 240, for storing various data files to be processed and/or transmitted by the computing device 200. The computing device 200 may also include program instructions stored in the ROM 230, RAM 240, and/or other type of non-transitory storage medium to be executed by the processor 220. The methods and/or processes of the present disclosure may be implemented as the program instructions. The computing device 200 may also include an I/O component 260, supporting input/output between the computer and other components. The computing device 200 may also receive programming and data via network communications.

Merely for illustration, only one processor is described in FIG. 2. Multiple processors are also contemplated, thus operations and/or steps performed by one processor as described in the present disclosure may also be jointly or separately performed by the multiple processors. For example, if in the present disclosure the processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

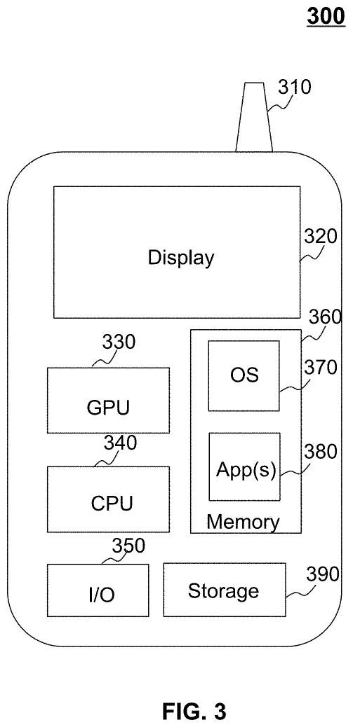

FIG. 3 is a schematic diagram illustrating exemplary hardware and/or software components of an exemplary mobile device according to some embodiments of the present disclosure. In some embodiments, the terminal device 130 may be implemented on the mobile device 300. As illustrated in FIG. 3, the mobile device 300 may include a communication platform 310, a display 320, a graphic processing unit (GPU) 330, a central processing unit (CPU) 340, an I/O 350, a memory 360, a mobile operating system (OS) 370, and a storage 390. In some embodiments, any other suitable component, including but not limited to a system bus or a controller (not shown), may also be included in the mobile device 300.

In some embodiments, the mobile operating system 370 (e.g., iOS™′ Android™, Windows Phone™) and one or more applications 380 may be loaded into the memory 360 from the storage 390 in order to be executed by the CPU 340. The applications 380 may include a browser or any other suitable mobile apps for receiving and rendering information relating to navigation services or other information from the navigation service system 100. User interactions with the information stream may be achieved via the I/O 350 and provided to the processing engine 112 and/or other components of the navigation service system 100 via the network 120.

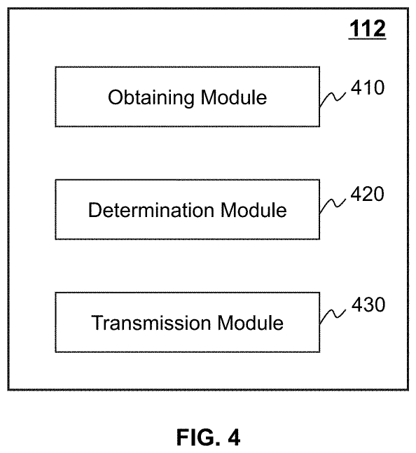

FIG. 4 is a block diagram illustrating an exemplary processing engine according to some embodiments of the present disclosure. The processing engine 112 may include an obtaining module 410, a determination module 420, and a transmission module 430.

The obtaining module 410 may be configured to obtain a start location and a destination of a navigation request from a terminal device (e.g., the terminal device 130). In some embodiments, the obtaining module 410 may obtain the start location and/or the destination of the navigation request based on a user input (e.g., a keyboard input, a voice input, an image input) associated with a subject (e.g., a user, a cycle, a vehicle, an autonomous vehicle). In some embodiments, the obtaining module 410 may obtain the start location and/or the destination of the navigation request based on positioning information associated with the terminal device 130. In some embodiments, the obtaining module 410 may determine a commonly used start location and/or a commonly used destination based on historical navigation requests associated with the subject and recommend the commonly used start location and/or the commonly used destination to a user associated with the subject when the user intends to initiate a navigation request.

The determination module 420 may be configured to determine a navigation path based on the start location and the destination. In some embodiments, the determination module 420 may determine a plurality of candidate navigation paths and select a target navigation path from the plurality of candidate navigation paths.

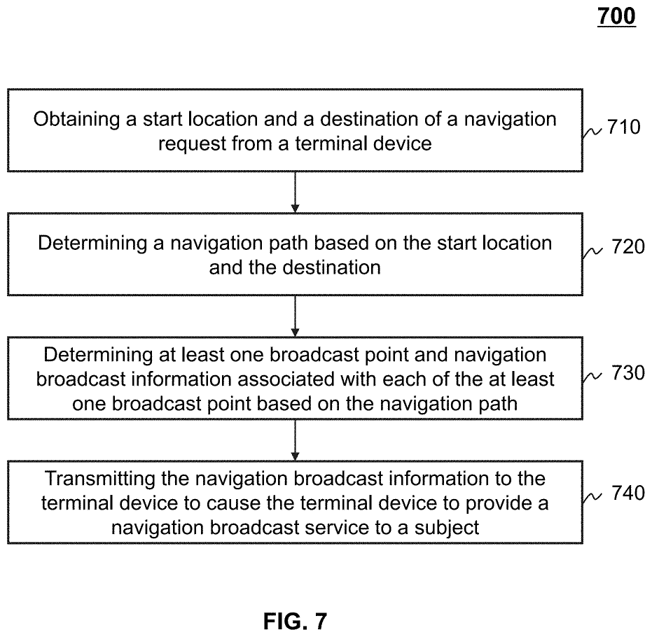

In some embodiments, the determination module 420 may also be configured to determine at least one broadcast point and navigation broadcast information associated with each of the at least one broadcast point based on the navigation path. More descriptions of the at least one broadcast point and the navigation broadcast information may be found elsewhere in the present disclosure (e.g., FIG. 7 and the description thereof).

The transmission module 430 may be configured to transmit the navigation broadcast information to the terminal device to cause the terminal device to provide a navigation broadcast service to the subject.

In some embodiments, the determination module 420 may obtain at least one recommendation based on the navigation path and the transmission module 430 may transmit the at least one recommendation to the terminal device 130 during providing the navigation broadcast service for the subject. The at least one recommendation may include a gas station recommendation, a vehicle maintenance recommendation, a personalized recommendation, or the like, or any combination thereof.

The modules in the processing engine 112 may be connected to or communicated with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a BLUETOOTH, a ZIGBEE, a Near Field Communication (NFC), or the like, or any combination thereof. Two or more of the modules may be combined into a single module, and any one of the modules may be divided into two or more units. For example, the processing engine 112 may include a storage module (not shown) used to store the at least one broadcast point and the navigation broadcast information associated with each of the at least one broadcast point.

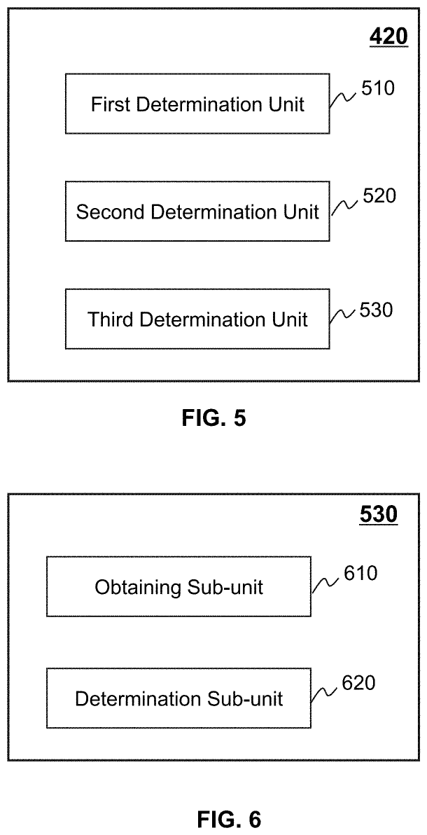

FIG. 5 is a block diagram illustrating an exemplary determination module according to some embodiments of the present disclosure. The determination module 420 may include a first determination unit 510, a second determination unit 520, and a third determination unit 530.

The first determination unit 510 may be configured to determine the navigation path based on the start location and the destination of the navigation request.

The second determination unit 520 may be configured to determine the at least one broadcast point on the navigation path.

The third determination unit 530 may be configured to determine the navigation broadcast information associated with each of the at least one broadcast point.

FIG. 6 is a block diagram illustrating an exemplary third determination unit according to some embodiments of the present disclosure. The third determination unit 530 may include an obtaining sub-unit 610 and a determination sub-unit 620.

The obtaining sub-unit 610 may be configured to obtain reference information associated with a sequence of links which may be determined based on the navigation path. In some embodiments, the reference information associated with the sequence of links may include a turning angle (e.g., an angle between two adjacent links), a road line type, a lane change, etc.

The determination sub-unit 620 may be configured to determine the navigation broadcast information associated with the at least one broadcast point based on the reference information.

FIG. 7 is a flowchart illustrating an exemplary process for providing a navigation service according to some embodiments of the present disclosure. In some embodiments, the process 700 may be implemented as a set of instructions (e.g., an application) stored in the storage ROM 230 or RAM 240. The processor 220 and/or modules and/or units in FIGS. 4-6 may execute the set of instructions, and when executing the instructions, the processor 220, and/or the modules, and/or the units may be configured to perform the process 700. The operations of the illustrated process presented below are intended to be illustrative. In some embodiments, the process 700 may be accomplished with one or more additional operations not described and/or without one or more of the operations herein discussed. Additionally, the order in which the operations of the process as illustrated in FIG. 7 and described below is not intended to be limiting.

In 710, the processing engine 112 (e.g., the obtaining module 410) (e.g., the interface circuits of the processor 220) may obtain a start location and a destination of a navigation request from a terminal device (e.g., the terminal device 130). The processing engine 112 may obtain the start location and the destination from the terminal device 130 via the network 120.

In some embodiments, the processing engine 112 may obtain the start location and/or the destination of the navigation request based on a user input (e.g., a keyboard input, a voice input, an image input) associated with a subject (e.g., a user, a cycle, a vehicle, an autonomous vehicle). For example, the terminal device 130 may obtain the start location and/or the destination via an online download, a voice recognition, or an image recognition based on the user input and transmit the start location and/or the destination to the processing engine 112. In some embodiments, a user associated with the subject may input the start location and/or the destination via a user interface (e.g., a user interface of a navigation application) of the terminal device 130. In some embodiments, the user can pre-set one or more keyboard shortcuts associated with one or more predetermined locations (e.g., home address, company address). When the user intends to initiate a navigation request, the user can press the one or more keyboard shortcuts and determine corresponding predetermined location(s) as the start location and/or the destination.

In some embodiments, the processing engine 112 may obtain the start location and/or the destination of the navigation request based on positioning information associated with the terminal device 130. For example, the terminal device 130 may obtain a current location via a positioning device (e.g., a GPS module) integrated in the terminal device 130 and transmit the current location to the processing engine 112. Further, the processing engine 112 may determine the current location as the start location.

In some embodiments, the processing engine 112 may determine a commonly used start location and/or a commonly used destination based on historical navigation requests associated with the subject and recommend the commonly used start location and/or the commonly used destination to the user when the user intends to initiate a navigation request.

In some embodiments, the navigation request may further include a travelling mode (e.g., a driving mode, a riding mode, a walking mode, an autonomous driving mode), a user requirement (e.g., avoiding congestion sections, no freeways, no toll fee, fastest path, shortest path) preset by the user, navigation broadcast settings (e.g., a broadcast voice, a broadcast speed, a broadcast volume), etc.

In 720, the processing engine 112 (e.g., the determination module 420) (e.g., the processing circuits of the processor 220) may determine a navigation path based on the start location and the destination.

In some embodiments, the processing engine 112 may determine the navigation path based on a path planning technique and/or a path planning algorithm. For example, the path planning technique may include a machine learning technique, an artificial intelligence technique, a template approach technique, an artificial potential field technique, or the like, or any combination thereof. The path planning algorithm may include a double direction A-star algorithm, an A-star algorithm, a sample algorithm, or the like, or any combination thereof.

In some embodiments, the processing engine 112 may determine a plurality of candidate navigation paths and select a target navigation path from the plurality of candidate navigation paths.

In some embodiments, the processing engine 112 may determine a plurality of distances corresponding to the plurality of candidate navigation paths. As used herein, “distance” may refer to a linear distance or a road distance. The processing engine 112 may rank the plurality of candidate navigation paths based at least in part on the plurality of distances and determine a first ranking result. Further, the processing engine 112 may determine the target navigation path based on the first ranking result. For example, the processing engine 112 may identify a target distance (e.g., the shortest one, the second shortest one) of the plurality of distances based on the first ranking result. The processing engine 112 may select, from the plurality of candidate navigation paths, a candidate navigation path associated with the target distance (e.g., the candidate navigation path associated with the shortest distance) as the target navigation path.

In some embodiments, the processing engine 112 may determine a plurality of traffic congestion levels (e.g., an average congestion level, a global congestion level) corresponding to the plurality of candidate navigation paths. The processing engine 112 may rank the plurality of candidate navigation paths based at least in part on the plurality of traffic congestion levels and determine a second ranking result. Further, the processing engine 112 may determine the target navigation path based on the second ranking result. For example, the processing engine 112 may identify a target traffic congestion level (e.g., the smallest one, the second smallest one) of the plurality of traffic congestion levels based on the second ranking result. The processing engine 112 may select, from the plurality of candidate navigation paths, a candidate navigation path associated with the target traffic congestion level (e.g., the candidate navigation path associated with the smallest traffic congestion level) as the target navigation path.

In some embodiments, the processing engine 112 may determine a plurality of estimated times of arrival (ETAs) corresponding to the plurality of candidate navigation paths. The processing engine 112 may rank the plurality of candidate navigation paths based at least in part on the plurality of ETAs and determine a third ranking result. Further, the processing engine 112 may determine the target navigation path based on the third ranking result. For example, the processing engine 112 may identify a target ETA (e.g., the shortest ETA, the second shortest ETA) of the plurality of ETAs based on the third ranking result. The processing engine 112 may select, from the plurality of candidate navigation paths, a candidate navigation path associated with the target ETA (e.g., the candidate navigation path associated with the shortest ETA) as the target navigation path.

In some embodiments, the processing engine 112 may rank the plurality of candidate navigation paths based on a combination of the above factors (e.g., the distances, the traffic congestion levels, the ETAs). For example, the processing engine 112 may assign different weighting coefficients to the “distance,” the “traffic congestion level,” and the “ETA” (e.g., assigning 0.3 to the “distance,” 0.3 to the “traffic congestion level,” and 0.4 to the “ETA”). For each of the plurality of candidate navigation paths, the processing engine 112 may determine a comprehensive parameter (i.e., a combination of the distance, the traffic congestion level, and the ETA) based on the weighting coefficients. The processing engine 112 may rank the plurality of candidate navigation paths based on a plurality of comprehensive parameters and determine a fourth ranking result. The processing engine 112 may determine the target navigation path based on the fourth ranking result. For example, the processing engine 112 may identify a target comprehensive parameter (e.g., the minimum one, the second minimum one) based on the fourth ranking result. The processing engine 112 may select, from the plurality of candidate navigation paths, a candidate navigation path associated with the target comprehensive parameter (e.g., the candidate navigation path associated with the minimum comprehensive parameter) as the target navigation path.

In some embodiments, the processing engine 112 may select the target navigation path from the plurality of candidate navigation paths based on historical requests associated with the subject. For example, for a specific start location and a specific destination, the processing engine 112 may determine a commonly used navigation path based on the historical requests and recommend the commonly used navigation path to the user. In some embodiments, the processing engine 112 may transmit the plurality of candidate navigation paths to the terminal device 130 to be selected by the user.

In 730, the processing engine 112 (e.g., the determination module 420) (e.g., the processing circuits of the processor 220) may determine at least one broadcast point and navigation broadcast information associated with each of the at least one broadcast point based on the navigation path. As used herein, the broadcast point refers to a point on the navigation path, and during a navigation broadcast service provided to the subject, when the subject approaches the broadcast point, the navigation broadcast information associated with the broadcast point will be broadcast to the subject.

In some embodiments, the navigation broadcast path may include a sequence of links (each of which corresponds to a road section). The processing engine 112 may determine reference information associated with the sequence of links and determine the at least one broadcast point and the navigation broadcast information associated with each of the at least one broadcast point based on the reference information. In some embodiments, the reference information associated with the sequence of links may include a turning angle (e.g., an angle between two adjacent links), a road line type, a lane change, etc.

In some embodiments, the processing engine 112 may determine intersection point(s) between any two adjacent links as the at least one broadcast point. For example, it is assumed that the sequence of links include a link A, a link B, link C, etc. In this situation, the at least one broadcast point may include an intersection point between the link A and the link B, an intersection point between the link B and the link C, etc.

In some embodiments, the processing engine 112 may determine start points and end points of the sequence of links as the at least one broadcast point.

In some embodiments, the processing engine 112 may determine one or more significant points (also referred to as “target points”) on the navigation path as the at least one broadcast point, for example, an intersection, a turning point, an on-ramp point, an off-ramp point, a congestion point, a road construction point, an accident point, a traffic monitoring point, a slippery road point, etc.

After determining the at least one broadcast point, the processing engine 112 may determine the navigation broadcast information (also referred to as “first navigation broadcast information” or a “set of first navigation broadcast information”) associated with the at least one broadcast point based on relevant information (which is included in the reference information associated with the sequence of links) associated with each of the at least one broadcast point. Take a specific broadcast point as an example, the relevant information may include a turning angle of the specific broadcast point, a road line type of a road where the broadcast point is located, a lane change, etc.

In some embodiments, also take the specific broadcast point as an example, during the navigation broadcast service provided to the subject, specific navigation broadcast information associated with the specific broadcast point may be broadcast to the subject in a multi-round mode, wherein during the process from the first round to the last round, the subject approaches closer and closer to the specific broadcast point.

In some embodiments, the navigation broadcast information may include at least one placeholder (e.g., “[ ],” “**,” “( )”) to be replaced by (or to be filled by, to be placed with) reminder information (e.g., distance reminder information, velocity reminder information) during the navigation broadcast service.

For example, it is assumed that a specific broadcast point is a left turning point, specific navigation broadcast information associated with the specific broadcast point may be expressed as below:
first round: “please continue to move [xx kilometer(s)] along the current road, take the left middle lane;”
second round: “after [xx kilometer(s)], take the left middle lane, then turn left and enter the Century Avenue;”
third round: “after [xxmeter(s)], take the left lane in the trigeminal intersection, then turn left and enter the Century Avenue.”

As another example, it is assumed that a specific broadcast point is a right turning point, specific navigation broadcast information associated with the specific broadcast point may be expressed as below:
first round: “please continue to move [xx kilometer(s)] along the current road, take the left middle lane;”
second round: “after [xx kilometer(s)], take the left middle lane, then turn right and enter Dongbeiwang Road;”
third round: “after [xx kilometer(s)], take the left middle lane, then turn right and enter Dongbeiwang Road;”
fourth round: “after [xx meter(s)], take the left middle lane in the trigeminal intersection, then turn right and enter Dongbeiwang Road;”
fifth round: “[xxxxxx], after xx meter(s)], take the left middle lane in the trigeminal intersect, then turn right and enter Dongbeiwang Road;”
sixth round (last round): “[xxxxxx], enter the Dongbeiwang Road.”

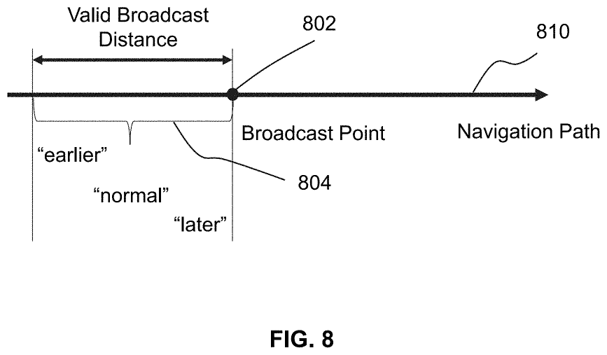

In some embodiments, the navigation broadcast information may further include a valid broadcast distance, a broadcast attribute, etc. Also take the specific broadcast point as an example, the valid broadcast distance may refer to a distance (e.g., a linear distance, a road distance) of a segment before the specific broadcast point on the navigation path, within which the specific navigation broadcast information associated with the specific broadcast point may be broadcast to the subject. The broadcast attribute may refer to a predetermined timing setting (e.g., “earlier,” “normal,” “later”) of the specific navigation broadcast information associated with the specific navigation point within the valid broadcast distance. More descriptions of the valid broadcast distance and/or the broadcast attribute may be found elsewhere in the present disclosure (e.g., FIG. 8 and the description thereof).

In 740, the processing engine 112 (e.g., the transmission module 430) (e.g., the interface circuits of the processor 220) may transmit the navigation broadcast information to the terminal device to cause the terminal device to provide a navigation broadcast service to the subject.

In some embodiments, the navigation broadcast service is provided by placing distance reminder information (also referred to as “distance information”) or velocity reminder information (also referred to as “velocity information”) in the at least one placeholder (which can be referred to as “second navigation broadcast information”) based on a current travelling state of the subject.

In some embodiments, the distance reminder information may include “50 meters,” “100 meters,” “1 kilometers,” etc. The velocity reminder information may include “please slow down,” “slow down,” “speed limit 80 km/h,” “school ahead, slow down, please,” etc.

In some embodiments, the current travelling state of the subject may include a current location of the subject, a current velocity of the subject, a current acceleration of the subject, etc. The current travelling state of the subject may be determined based on positioning information (e.g., GPS information).

For example, as described above, it is assumed that the specific broadcast point is a left turning point, during the navigation broadcast service is provided to the subject, the distance reminder information may be placed in the placeholders included in the specific navigation broadcast information (i.e., the first navigation broadcast information) associated with the specific navigation point to obtain the second navigation broadcast information expressed as below:
first round: “please continue to move [300 kilometers] along the current road, take the left middle lane;”
second round: “after [100 kilometers], take the left middle lane, then turn left and enter the Century Avenue;”
third round: “after [20 meters], take the left lane in the trigeminal intersection, then turn left and enter the Century Avenue.”

As another example, also as described above, it is assumed that the specific broadcast point is a right turning point, during the navigation broadcast service is provided to the subject, the distance reminder information and the velocity reminder information may be placed in the placeholders included in the specific navigation broadcast information (i.e., the first navigation broadcast information) associated with the specific navigation point to obtain the second navigation broadcast information expressed as below:
first round: “please continue to move [5 kilometers] along the current road, take the left middle lane;”
second round: “after [2 kilometers], take the left middle lane, then turn right and enter Dongbeiwang Road;”
third round: “after [1 kilometer], take the left middle lane, then turn right and enter Dongbeiwang Road;”
fourth round: “after [500 meters], take the left middle lane in the trigeminal intersection, then turn right and enter Dongbeiwang Road;”
fifth round: “[please slow down] after 200 meters], take the left middle lane in the trigeminal intersect, then turn right and enter Dongbeiwang Road;”
sixth round (last round): “[turn right], enter the Dongbeiwang Road.”
   Take the first round as an example, the distance reminder information is determined based on a current distance between the current location of the subject and the specific broadcast point. Take the fifth round as an example, the velocity reminder information is determined based on the current velocity of the subject (if the current velocity is larger than a threshold, a velocity reminder information “slow down” may be determined); the distance reminder information is determined based on a current distance between the current location of the subject and the specific broadcast point.

In some embodiments, the processing engine 112 may write the navigation broadcast information to a cache of the navigation service system 100 and transmit the navigation broadcast information as well as a command to an output port (e.g., an antenna) of the navigation service system 100, wherein the command is configured to direct the output port to send communication signals (e.g., an electronic signal, a wireless signal) to cause the terminal device 130 to present the navigation broadcast information on a screen (e.g., the display 320) of the terminal device 130.

In some embodiments, the navigation broadcast service may be provided in a voice broadcast mode or a text broadcast mode. In some embodiments, during the navigation broadcast service, the terminal device 130 may present the navigation broadcast information in a form of a text description, a graphical illustration, an audio description, etc. The terminal device 130 may also present the navigation path, the at least one navigation point, the current travelling state of the subject, weather information, traffic condition information, etc.

In some embodiments, a broadcast speed of the navigation broadcast information may be adjusted based on the current travelling state of the subject. For example, when the subject enters the valid broadcast distance and the current velocity of the subject is larger than a velocity threshold, the broadcasting of the navigation broadcast information may be speed up.

In some embodiments, the processing engine 112 may obtain at least one recommendation based on the navigation path and transmit the at least one recommendation to the terminal device 130 during providing the navigation broadcast service for the subject. The at least one recommendation may include a gas station recommendation, a vehicle maintenance recommendation, a personalized recommendation, or the like, or any combination thereof. In some embodiments, the personalized recommendation may be determined automatically, manually, or semi-automatically. For example, the personalized recommendation may be predetermined by the subject. As another example, the personalized recommendation may be determined based on a data statistics approach. As a further example, the personalized recommendation may be determined based on a machine learning model.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

For example, one or more other optional operations (e.g., a storing operation) may be added elsewhere in the process 700. In the storing operation, the processing 112 may store the at least one broadcast point and/or the navigation broadcast information associated with each of the at least one broadcast point in a storage device (e.g., the storage 140) disclosed elsewhere in the present disclosure. As another example, the at least one placeholder may be unnecessary and the navigation broadcast information may be complete. As a further example, the processing engine 112 may determine at least two target navigation paths and transmit at least one broadcast point and navigation broadcast information associated with the at least two target navigation paths to the terminal device 130. As still a further example, the processing engine 112 may dynamically adjust the navigation path(s), the at least one broadcast point, and/or the navigation broadcast information based on traffic condition information during the navigation broadcast service.

FIG. 8 is a schematic diagram illustrating exemplary navigation broadcast information according to some embodiments of the present disclosure. As illustrated in FIG. 8, take a specific broadcast point 802 on a navigation path 810 as an example, as described elsewhere in the present disclosure, specific navigation broadcast information associated with the specific broadcast point 802 may include a valid broadcast distance and a broadcast attribute.

The valid broadcast distance refers to a distance of a segment 804 (which is before the specific broadcast point) on the navigation path, within which the specific navigation broadcast information may be broadcast to a subject during a navigation broadcast service. The valid broadcast distance may be a default setting of the navigation service system 100 or may be adjustable under different situations. For example, the larger a velocity of the subject is, the longer the valid broadcast distance may be; whereas, the smaller the velocity of the subject is, the shorter the valid broadcast distance may be.

The broadcast attribute refers to a predetermined timing setting (e.g., “earlier,” “normal,” “later”) of the specific navigation broadcast information associated with the specific navigation point 802 within the valid broadcast distance.

As used herein, “earlier” indicates that the sooner the specific navigation broadcast information can be broadcast to the subject, the better, for example, the specific navigation broadcast information may be broadcast to the subject once the subject enters into the segment 804 (i.e., enters into the valid broadcast distance); “normal” indicates that the specific navigation broadcast information can be broadcast to the subject at an intermediate stage of the valid broadcast distance, for example, the specific navigation broadcast information may be broadcast to the subject at predetermined position (e.g., a ¼ position, a ⅓ position, a middle position, a ⅔ position) within the valid broadcast distance; “later” refers to that the later the specific navigation broadcast information can be broadcast to the subject, the better, for example, the specific navigation broadcast information may be broadcast to the subject when the subject is about to leave the segment 804 (i.e., leave the valid broadcast distance).

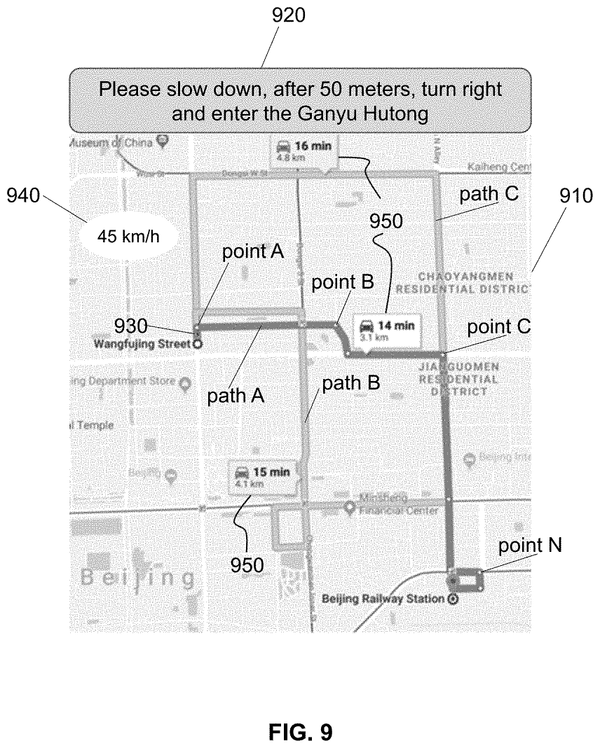

FIG. 9 is a schematic diagram illustrating an exemplary navigation interface according to some embodiments of the present disclosure.

As illustrated in FIG. 9, the navigation interface 900 may include a map area 910 and a navigation broadcast area 920. As described elsewhere in the present disclosure, the processing engine 112 may determine one or more navigation paths (e.g., a path A, a path B, a path C) based on a start location (e.g., the Wanfujing Street) and a destination (e.g., Bejing Railway Station). Take the path A as an example, the processing engine 112 determine at least one broadcast point (e.g., a point A, a point B, a point C, . . . , a point N) and navigation broadcast information associated with each of the at least one broadcast point. Further, the processing engine 112 may transmit the navigation path(s), the at least one broadcast point, and the navigation broadcast information to the terminal device 130 to cause the terminal device 130 to provide a navigation broadcast service and present the above information on the navigation interface 900.

In some embodiments, the navigation interface 900 may also include one or more user interface elements (also referred to as “UI elements”) for presenting a current location 930, a current velocity 940, estimated parameters 950 (e.g., an estimated travelling distance, an ETA) associated with the navigation paths, etc.

In some embodiments, as described elsewhere in the present disclosure, the navigation broadcast information may include at least one placeholder to be replaced by reminder information. Take the point A (which is a right turning point) on the path A as an example, corresponding navigation broadcast information may be expressed as below:

[xxxxx], after [xx meters], turn right and enter the Ganyu Hutong

During the navigation broadcast service, the placeholders are placed with velocity reminder information (which is determined based on the current velocity) and distance reminder information (which is determined based on the current location). Accordingly, complete navigation broadcast information may be expressed as below:

Please slow down, after [50 meters], turn right and enter the Ganyu Hutong

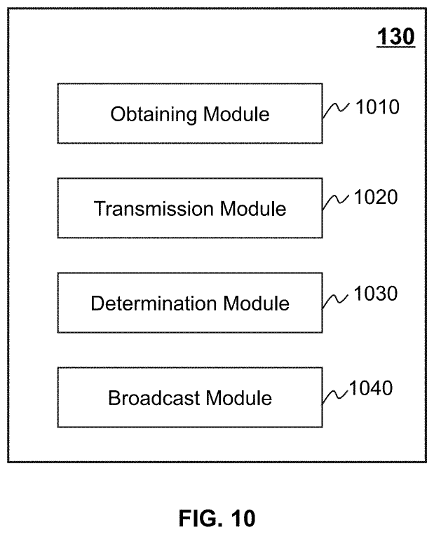

FIG. 10 is a block diagram illustrating an exemplary terminal device according to some embodiments of the present disclosure. The terminal device 130 may include an obtaining module 1010, a transmission module 1020, a determination module 1030, and a broadcast module 1040.

The obtaining module 1010 may be configured to obtain a start location and a destination of a navigation request. In some embodiments, the obtaining module 1010 may obtain the start location and/or the destination of the navigation request based on a user input (e.g., a keyboard input, a voice input, an image input) associated with a subject (e.g., a user, a cycle, a vehicle, an autonomous vehicle). In some embodiments, the obtaining module 1010 may determine a current location via a positioning device (e.g., a GPS module) integrated in the terminal device 130 as the start location.

In some embodiments, the obtaining module 1010 may be also configured to obtain a current traveling state (e.g., a current location, a current velocity) of the subject. In some embodiments, the obtaining module 1010 may be also configured to obtain at least one recommendation which is determined based on a navigation path. The at least one recommendation may include a gas station recommendation, a vehicle maintenance recommendation, a personalized recommendation, etc.

The transmission module 1020 may be configured to transmit the start location and the destination to the server 110. In some embodiments, the transmission module 1020 may transmit the start location and the destination to the server 110 via a data exchange port that is communicatively connected to the network 120. In some embodiments, the transmission module 1020 may transmit the start location and the destination to the server 110 according to any suitable communication protocol, for example, Hypertext Transfer Protocol (HTTP), Address Resolution Protocol (ARP), Dynamic Host Configuration Protocol (DHCP), File Transfer Protocol (FTP), etc.

The determination module 1030 may be configured to obtain at least one broadcast point and navigation broadcast information (also referred to as “first navigation broadcast information”) from the server 110. The first navigation broadcast information may include at least one placeholder to be replaced by (or to be filled by, to be placed with) reminder information (e.g., distance reminder information, velocity reminder information).

The broadcast module 1040 may be configured to provide a navigation broadcast service for a subject based on the navigation broadcast information. In some embodiments, the broadcast module 1040 may determine second navigation broadcast information based on the first navigation broadcast information and the current travelling state of the subject. The broadcast module 1040 may determine the second navigation broadcast information by placing the distance reminder information or the velocity reminder information in the at least one placeholder included in the first navigation broadcast information based on the current travelling state of the subject.

In some embodiments, the broadcast module 1040 may provide the navigation broadcast service in a voice broadcast mode or a text broadcast mode. In some embodiments, the broadcast module 1040 may adjust a broadcast speed of the navigation broadcast information based on the current travelling state of the subject. In some embodiments, during the navigation broadcast service, the terminal device 130 may present the navigation broadcast information in a form of a text description, a graphical illustration, an audio description, etc. The terminal device 130 may also present the navigation path, the at least one navigation point, the current travelling state of the subject, weather information, traffic condition information, etc.

In some implementations, the terminal device 130 may also include a processing module, a positioning module, a wireless communication module, a storage module, a display module, etc.

The modules in the terminal device 130 may be connected to or communicated with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a BLUETOOTH, a ZIGBEE, a Near Field Communication (NFC), or the like, or any combination thereof. Two or more of the modules may be combined into a single module, and any one of the modules may be divided into two or more units. For example, the terminal device 130 may include a storage module (not shown) used to store the start location, the destination, the at least one broadcast point, the navigation broadcast information, etc. As another example, the obtaining module 1010 and the determination module 1030 may be combined as a single module. As a further example, the at least one broadcast point and the first navigation broadcast information may be obtained by the obtaining module 1010. As still further example, the second navigation broadcast information may be determined by the determination module 1030.

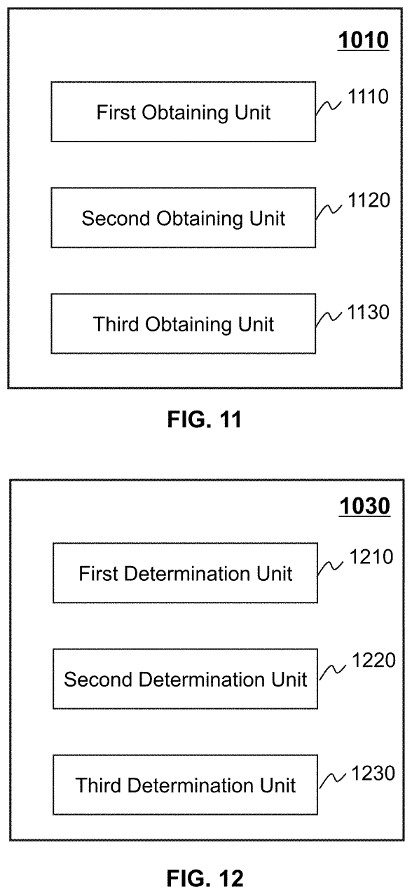

FIG. 11 is a block diagram illustrating an exemplary obtaining module according to some embodiments of the present disclosure. The obtaining module 1010 may include a first obtaining unit 1110, a second obtaining unit 1120, and a third obtaining unit 1130.

The first obtaining unit 1110 may be configured to obtain the start location and destination of the navigation request.

The second obtaining unit 1120 may be configured to obtain a current travelling state of the subject. In some embodiments, the current travelling state of the subject may include a current location of the subject, a current velocity of the subject, a current acceleration of the subject, etc. The current travelling state of the subject may be determined based on positioning information (e.g., GPS information).

The third obtaining unit 1130 may be configured to obtain the first navigation broadcast information from the server 110.

FIG. 12 is a block diagram illustrating an exemplary determination module according to some embodiments of the present disclosure. The determination module 1030 may include a first determination unit 1210, a second determination unit 1220, and a third determination unit 1230.

The first determination unit 1210 may be configured to determine a specific broadcast point based on the current travelling state of the subject during the navigation broadcast service.

The second determination unit 1220 may be configured to determine the first navigation broadcast information associated with the specific broadcast point.

The third determination unit 1230 may be configured to place the distance reminder information or the velocity reminder information in the at least one placeholder (which can be referred to as “second navigation broadcast information”) based on the current travelling state of the subject.

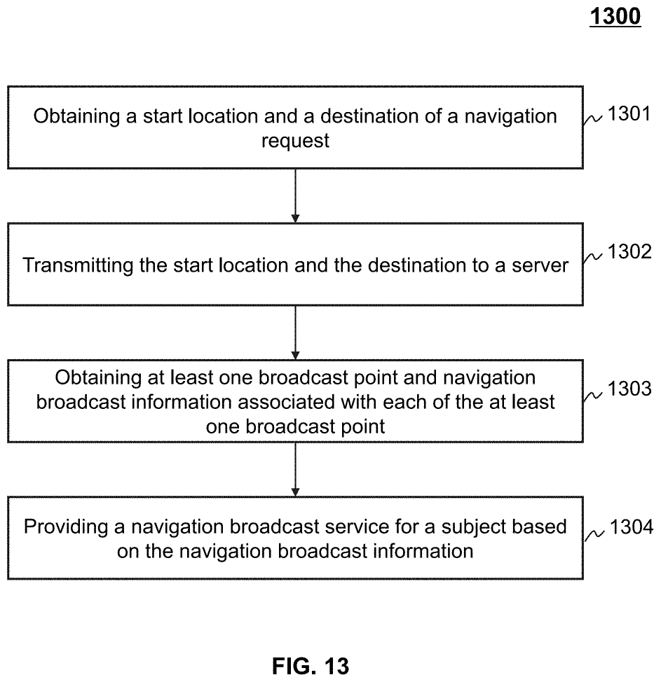

FIG. 13 is a flowchart illustrating an exemplary process for providing a navigation service according to some embodiments of the present disclosure. In some embodiments, the process 1300 may be implemented as a set of instructions (e.g., an application) stored in the storage ROM 230 or RAM 240. The processor 220 and/or the modules and/or units in FIGS. 10-12 may execute the set of instructions, and when executing the instructions, the processor 220 and/or the modules and/or the units may be configured to perform the process 1300. The operations of the illustrated process presented below are intended to be illustrative. In some embodiments, the process 1300 may be accomplished with one or more additional operations not described and/or without one or more of the operations herein discussed. Additionally, the order in which the operations of the process as illustrated in FIG. 13 and described below is not intended to be limiting.

In 1310, the terminal device 130 (e.g., the obtaining module 1010) may obtain a start location and a destination of a navigation request.

In some embodiments, the terminal device 130 may obtain the start location and/or the destination of the navigation request based on a user input (e.g., a keyboard input, a voice input, an image input) associated with a subject (e.g., a user, a cycle, a vehicle, an autonomous vehicle). For example, the terminal device 130 may obtain the start location and/or the destination via an online download, a voice recognition, or an image recognition based on the user input. In some embodiments, a user associated with subject may input the start location and/or the destination via a user interface (e.g., a user interface of a navigation application) of the terminal device 130. In some embodiments, the user can pre-set one or more keyboard shortcuts associated with one or more predetermined locations (e.g., home address, company address). When the user intends to initiate a navigation request, the user can press the one or more keyboard shortcuts and determine corresponding predetermined location(s) as the start location and/or the destination.

In some embodiments, the terminal device 130 may determine a current location via a positioning device (e.g., a GPS module) integrated in the terminal device 130 as the start location. More descriptions of the start location and/or the destination may be found elsewhere in the present disclosure (e.g., FIG. 7 and the description thereof).

In some embodiments, the navigation request may further include a travelling mode (e.g., a driving mode, a riding mode, a walking mode, an autonomous driving mode), a user requirement (e.g., avoiding congestion sections, no freeways, no toll fee, fastest path, shortest path) preset by the user, navigation broadcast settings (e.g., a broadcast voice, a broadcast speed, a broadcast volume), etc.

In 1320, the terminal device 130 (e.g., the transmission module 1020) may transmit the start location and the destination to a server (e.g., the server 110).

In some embodiments, the terminal device 130 may transmit the start location and the destination to the server 110 via a data exchange port that is communicatively connected to the network 120. In some embodiments, the terminal device 130 may transmit the start location and the destination to the server 110 according to any suitable communication protocol, for example, Hypertext Transfer Protocol (HTTP), Address Resolution Protocol (ARP), Dynamic Host Configuration Protocol (DHCP), File Transfer Protocol (FTP), etc.

As described in connection with operation 720, the server 110 (e.g., the processing engine 112) (e.g., the processing circuits of the processor 220) may determine at least one navigation path based on the start location and the destination. Further, as described in connection with operation 730, the server 110 may also determine at least one broadcast point and navigation broadcast information (also can be referred to as “first navigation broadcast information) associated with each of the at least one broadcast point based on the at least one navigation path.

In 1330, the terminal device 130 (e.g., the obtaining module 1010) may obtain the at least one broadcast point and the navigation broadcast information associated with each of the at least one broadcast point from the server 110 or a storage device (e.g., the storage 140) disclosed elsewhere in the present disclosure.

As described elsewhere in the present disclosure, the navigation broadcast path may include a sequence of links (each of which corresponds to a road section); and the at least one broadcast point may include intersection point(s) between any two adjacent links, start points and end points of the sequence of links, one or more significant points (e.g., an intersection, a turning point, an on-ramp point, an off-ramp point, a congestion point, a road construction point, an accident point, a traffic monitoring point, a slippery road point), etc.

In some embodiments, the navigation broadcast information may include at least one placeholder (e.g., “[ ],” “**,” “( )”) to be replaced by (or to be filled by, to be placed with) reminder information (e.g., distance reminder information, velocity reminder information) during the navigation broadcast service.

In some embodiments, the navigation broadcast information may further include a valid broadcast distance, a broadcast attribute, etc. Also take the specific broadcast point as an example, the valid broadcast distance may refer to a distance (e.g., a linear distance, a road distance) of a segment before the specific broadcast point on the navigation path, within which the specific navigation broadcast information associated with the specific broadcast point may be broadcast to the subject. The broadcast attribute may refer to a predetermined timing setting (e.g., “earlier,” “normal,” “later”) of the specific navigation broadcast information associated with the specific navigation point within the valid broadcast distance. More descriptions of the valid broadcast distance and/or the broadcast attribute may be found elsewhere in the present disclosure (e.g., FIG. 8 and the description thereof).

In 1340, the terminal device 130 (e.g., the providing module 1050) may provide a navigation broadcast service for a subject based on the navigation broadcast information.

As described in connection with operation 740, the terminal device 130 may place the distance reminder information or the velocity reminder information in the at least one placeholder (which can be referred to as “second navigation broadcast information”) based on a current travelling state of the subject.

In some embodiments, the distance reminder information may include “50 meters,” “100 meters,” “1 kilometers,” etc. The velocity reminder information may include “please slow down,” “speed limit 80 km/h,” “school ahead, slow down, please,” etc.

In some embodiments, the current travelling state of the subject may include a current location of the subject, a current velocity of the subject, a current acceleration of the subject, etc. The current travelling state of the subject may be determined based on positioning information (e.g., GPS information).

In some embodiments, the terminal device 130 may provide the navigation broadcast service in a voice broadcast mode or a text broadcast mode. In some embodiments, during the navigation broadcast service, the terminal device 130 may present the navigation broadcast information in a form of a text description, a graphical illustration, an audio description, etc. The terminal device 130 may also present the navigation path, the at least one navigation point, the current travelling state of the subject, weather information, traffic condition information, etc.

In some embodiments, the terminal device 130 may adjust a broadcast speed of the navigation broadcast information based on the current travelling state of the subject. For example, when the subject enters the valid broadcast distance and the current velocity of the subject is larger than a velocity threshold, the terminal device 130 may speed up the broadcasting of the navigation broadcast information.

In some embodiments, during providing the navigation broadcast service, the terminal device 130 may present at least one recommendation associated with the navigation path. The at least one recommendation may include a gas station recommendation, a vehicle maintenance recommendation, a personalized recommendation, or the like, or any combination thereof. In some embodiments, the personalized recommendation may be determined automatically, manually, or semi-automatically. For example, the personalized recommendation may be predetermined by the subject. As another example, the personalized recommendation may be determined based on a data statistics approach. As a further example, the personalized recommendation may be determined based on a machine learning model.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, one or more other optional operations (e.g., a storing operation) may be added elsewhere in the process 1300. In the storing operation, the terminal device 130 may store information and/or data (e.g., the start location, the destination, the at least one broadcast point, the navigation broadcast information) in a storage device (e.g., the storage 390) disclosed elsewhere in the present disclosure.

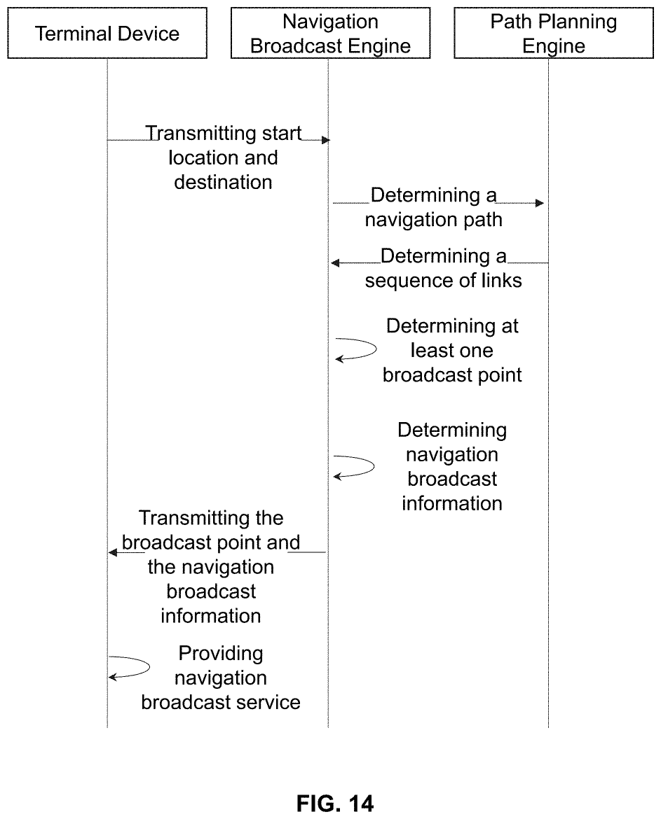

FIG. 14 is a schematic diagram illustrating an exemplary navigation service system according to some embodiments of the present disclosure. For convenience, only the processing engine (which includes a path planning engine and a navigation broadcast engine) and the terminal device are shown.

As described in connection with FIG. 7 and FIG. 13, the terminal device may obtain a start location and a destination of a navigation request and transmit the start location and the destination to the navigation broadcast engine via the network 120. After receiving the start location and the destination, the navigation broadcast engine may invoke the path planning engine to determine a navigation path. The path planning engine may return a sequence of links associated with the navigation path to the navigation broadcast engine. According to the sequence of links, the navigation broadcast engine may determine at least one broadcast point on the navigation path and further determine navigation broadcast information associated with each of the at least one broadcast point.

Further, the navigation broadcast engine may transmit the at least one broadcast point and the navigation broadcast information to the terminal device via the network 120. After receiving the at least one broadcast point and the navigation broadcast information, the terminal device may provide a navigation broadcast service for a subject.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1-24. (canceled)

25. A system for providing navigation services, comprising:
a storage device to store a set of instructions; and
a processor, communicatively coupled to the storage device, to execute the set of instructions to:
obtain, from a terminal device, a start location and a destination of a navigation request;
determine, based on the start location and the destination, a navigation path;
determine, based on the navigation path, at least one broadcast point and navigation broadcast information associated with each of the at least one broadcast point; and
transmit the navigation broadcast information to the terminal device to cause the terminal device to provide a navigation broadcast service to a subject.

26. The system of claim 25, wherein the navigation broadcast information comprises at least one placeholder to be replaced by reminder information.

27. The system of claim 26, wherein the navigation broadcast service is provided by placing distance reminder information or velocity reminder information in the at least one placeholder based on a current travelling state of the subject.

28. The system of claim 27, wherein the current travelling state including at least one of a current location of the subject or a current velocity of the subject.

29. The system of claim 27, wherein the current travelling state of the subject is determined based on positioning information.

30. The system of claim 25, wherein the navigation path comprises a sequence of road sections, and to determine, based on the navigation path, the at least one broadcast point and the navigation broadcast information associated with each of the at least one broadcast point, the processor is to:
determine reference information associated with the sequence of road sections, the reference information including at least one of an angle between any two adjacent road sections, a road line type, or a lane change; and
determine the at least one broadcast point and the navigation broadcast information associated with each of the at least one broadcast point based on the reference information.

31. The system of claim 25, wherein the navigation broadcast information comprises at least one of a valid broadcast distance or a broadcast attribute.

32. The system of claim 25, wherein the at least one broadcast point comprises an intersection, a turning point, an on-ramp point, or an off-ramp point.

33. The system of claim 25, wherein the navigation broadcast service is provided in at least one of a voice broadcast mode or a text broadcast mode.

34. The system of claim 25, wherein the processor is further to:
obtain at least one recommendation based on the navigation path, the at least one recommendation including at least one of a gas station recommendation, a vehicle maintenance recommendation, or a personalized recommendation; and
transmit the recommendation to the terminal device during providing the navigation broadcast service for the subject.

35. A method implemented on a computing device having at least one processor, at least one storage medium, and a communication platform connected to a network, the method comprising:
obtaining, from a terminal device, a start location and a destination of a navigation request;
determining, based on the start location and the destination, a navigation path;
determining, based on the navigation path, at least one broadcast point and navigation broadcast information associated with each of the at least one broadcast point; and
transmitting the navigation broadcast information to the terminal device to cause the terminal device to provide a navigation broadcast service to a subject.

36. The method of claim 35, wherein the navigation broadcast information comprises at least one placeholder to be replaced by reminder information.

37. The method of claim 36, wherein the navigation broadcast service is provided by placing distance reminder information or velocity reminder information in the at least one placeholder based on a current travelling state of the subject.

38. The method of claim 37, wherein the current travelling state includes at least one of a current location of the subject or a current velocity of the subject.

39. The method of claim 37, wherein the current travelling state of the subject is determined based on positioning information.

40. The method of claim 35, wherein the navigation path comprises a sequence of road sections, and determining, based on the navigation path, the at least one broadcast point and the navigation broadcast information associated with each of the at least one broadcast point comprises:
determining reference information associated with the sequence of road sections, the reference information including at least one of an angle between any two adjacent road sections, a road line type, or a lane change; and
determining the at least one broadcast point and the navigation broadcast information associated with each of the at least one broadcast point based on the reference information.

41. The method of claim 35, wherein the navigation broadcast information comprises at least one of a valid broadcast distance or a broadcast attribute.

42. The method of claim 35, wherein the at least one broadcast point comprises an intersection, a turning point, an on-ramp point, or an off-ramp point.

43. (canceled)

44. The method of claim 35, wherein the method further comprises:
obtaining at least one recommendation based on the navigation path, the at least one recommendation including at least one of a gas station recommendation, a vehicle maintenance recommendation, or a personalized recommendation; and
transmitting the recommendation to the terminal device during providing the navigation broadcast service for the subject.

45-55. (canceled)

56. A method implemented on a computing device including at least one processor, at least one storage medium, and a communication platform connected to a network, the method comprising:
obtaining a start location and a destination of a navigation request;
transmitting the start location and the destination to a server;
obtaining at least one broadcast point and navigation broadcast information associated with each of the at least one broadcast point, wherein at least one broadcast point and navigation broadcast information associated with each of the at least one broadcast point are determined based on a navigation path determined based on the start location and the destination; and
providing a navigation broadcast service to a subject.

57-67. (canceled)
